(19) United States
(12) Patent Application Publication
(10) Pub. No.: US 2012/0259720 A1
(43) Pub. Date: Oct. 11, 2012

(54) METHOD AND SYSTEM TO CONFIRM OWNERSHIP OF DIGITAL GOODS

(75) Inventor: Frank Anthony Nuzzi, Pflugerville, TX (US)

(73) Assignee: eBay Inc., San Jose, CA (US)

(21) Appl. No.: 13/081,367

(22) Filed: Apr. 6, 2011

(51) Int. Cl. G06Q 30/00

(52) U.S. Cl. 705/26.1

(57) ABSTRACT

A method and system to confirm ownership of digital goods is provided. In one embodiment, the method comprises receiving, from a client device via a data network interface, a request for a digital good, completing one or more micro transactions with respect to a financial account, generating a code utilizing information derived from the one or more micro transactions and embedding the code into a first copy of the digital good, the code to be used to confirm ownership of the digital good.

### TECHNICAL FIELD

This application relates to the technical fields of software and/or hardware technology and, in one example embodiment, to system and method to confirm ownership of digital goods.

### BACKGROUND

Digital Rights Management (“DRM”) is a term used to describe a range of techniques that use information about rights and rightsholders to manage proprietary content and the terms and conditions on which the content (e.g., digital goods, such as music or video clips) is made available to users. DRM-protected content is distributed, possibly together with a set of consumption rights, in encrypted form. Thus, only authorized parties, usually those that have paid for the content, are able to consume the content.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to confirm ownership of digital goods may be implemented;

FIG. 2 is block diagram of a system to generate code suitable to confirm ownership of digital goods, in accordance with one example embodiment;

FIG. 3 is a flow chart of a method to generate a code that can be used to confirm ownership of digital goods, in accordance with an example embodiment;

FIG. 4 is a flow chart of a method to recover a code that can be used to confirm ownership of digital goods, in accordance with an example embodiment;

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to confirm ownership of digital goods is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on administration of Java-based servers and related environments, the embodiments are given merely for clarity in disclosure. Thus, any type of server environment, including various system architectures, may employ various embodiments of the application-centric resources system and method described herein and is considered as being within a scope of the present invention.

In some existing systems, the owner (purchaser or consumer) of a digital good may be unable to send the purchased digital good to another person, as a purchased digital good may be tied to one or more specific devices. If the user who has purchased the digital good wishes to move the DRM-protected digital good to another device, the user may need to explicitly authorize that device. The number of devices that may be used to play back a DRM-protected digital good is often limited.

Method and system are provided to permit the owner of a digital good to confirm or recover ownership of previously purchased digital good utilizing information derived from series financial micro transactions. A financial micro transaction is a financial transaction that involves a deposit or a withdrawal of certain, typically small, amount to/from a financial account of a user.

The micro transactions that may be used to generate a DRM key could be a series of small debits and credits to/from a financial account that are identifiable only to the holder of the financial account. The financial institution that is being used by the payment processing system may be, e.g., an online payment provider, a credit card provider, a bank, etc. The consumer of the digital good may be instructed by the payment processing system, using a computer-implemented user interface (UI), to use information derived from the micro transaction as a software key in order to indicate that they are the owner of the digital goods. For example, the user may be instructed to type into a designated field the string consisting of the type of purchased digital good and the amount involved in the micro transaction. One of the advantages of using information derived from a micro transaction to authenticate an owner of a digital good is that a consumer's financial information, such as the amounts involved in transactions, is typically kept private to the consumer.

In operation, a user may indicate, using a computer-implemented user interface (UI), that she wishes to purchase a digital good, such as a song or a video. The user may also indicate whether the song is being purchased for themselves or for another consumer. In response to such request, a payment processing system (which may be an on-line financial transaction service) may process payment transaction for the user and also complete one or more micro transactions. The payment processing system may then embed into the digital good, as a DRM key or as part of a DRM key, information derived from the one or more micro transactions. In one example embodiment, a DRM key may be generated to include encrypted information about the user and the one or more micro transactions (e.g., the user's account number, the micro transaction amount, etc., e.g., using Secure Hash Algorithm (SHA). Thus generated DRM key, in one embodiment, is not designed to be decrypted and therefore cannot be manipulated to reveal the underlying information. The DRM key that the payment processing system embeds into the digital good may be utilized to authenticate a user as the owner of the digital good.

For example, when the user requests play back of media content that has DRM key embedded as described above, the embedded DRM key is extracted and communicated from the playback system (e.g., a playback system executing on the user's client computer or a portable playback device) to the computer system of the service provider, e.g., via a computer network communication. At the computer system of the service provider, the received DRM key is compared to the stored reference key. The authorization to play the media content is provided to the playback system only of the DRM key extracted from the media content matches the stored reference key.

In the instance were a user needs to reacquire a previously purchased digital good, e.g., where the owner has lost or no longer has access to the copy of the purchased digital good, the user may be instructed to make another series of small micro transactions directed to the user's financial account, using the same amount(s) as during the original micro transaction(s). The payment processing system would then recreate the DRM key for the purchased digital good, embed it in a new copy of the digital good and make it available to the user. A micro transaction may thus be used by the payment processing system to permit recovery by the consumer of a previously purchased digital good.

In one example embodiment, when a digital good is purchased, the producer or retailer of the digital good may contact the payment provider indicating that a purchase has been made. Upon electronic checkout, the purchaser of the digital good may identify the consumer of the digital good (either self or another person) and a preferred financial institution. In the case where the purchaser of the digital good is not the consumer, the purchaser may provide information identifying an online financial institution where the consumer could view the micro transaction amounts. In the case that the consumer is a customer of an online payment service, the purchaser may provide the consumer's email address (or other identification information) in lieu of the identification of the financial institution. In that case, the consumer would use their account with the online payment service to view the micro transactions and thus obtain information needed to access the digital good. In some embodiment, a producer of digital goods may be permitted to specify a default financial institution that is to be used for payment.

The payment processing system may be configured to perform a micro transaction, derive a key from data associated with the micro transaction, embed the derived key into the digital good that is being purchased, and make the digital good having the embedded key available to the consumer. In some embodiments, the payment processing system may transmit the purchased digital good to the consumer. In other embodiments, the payment processing system may transmit the digital good having the embedded key to the producer, so that the consumer can obtain the digital good from the producer of the digital good.

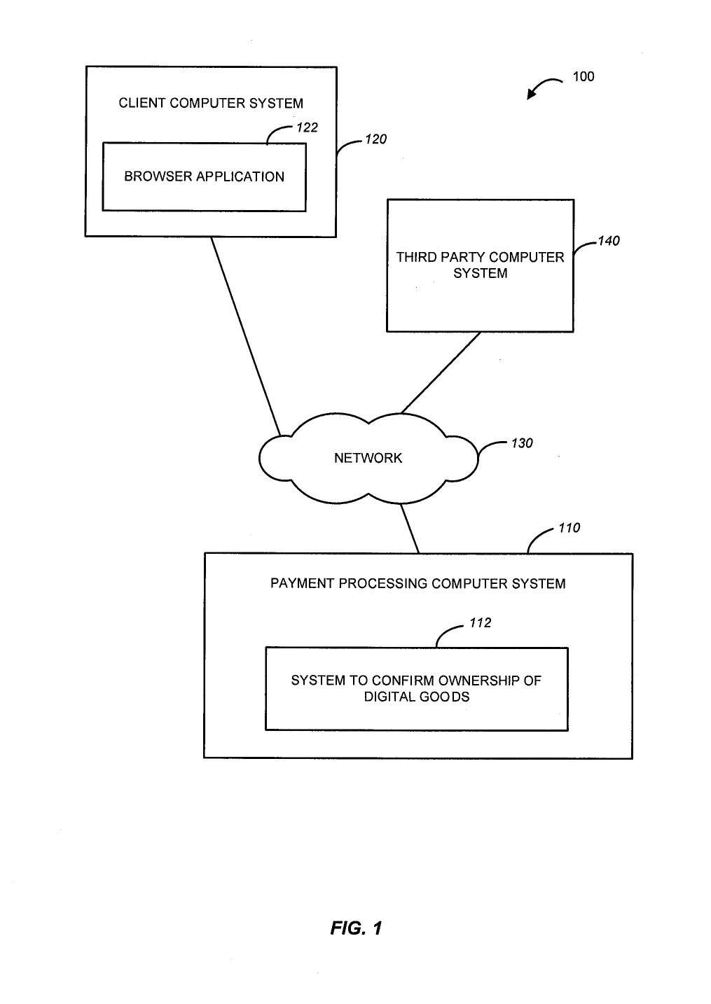

A series of micro transactions used for generating a DRM key could vary in the number of transactions, in amount, and in transaction type. For example, if the digital good is quite expensive, a payment processing system may use a greater number of micro transactions. For example, a payment processing system may use two micro transactions comprising two small deposits to generate a DRM key for a digital good that costs one dollar, but four micro transactions comprising both deposit and withdrawal amounts to generate a DRM key for a digital good that costs one hundred dollars. An example method and system to confirm ownership of digital goods may be implemented in the context of a network environment illustrated in FIG. 1.

As shown in FIG. 1, a network environment 100 may include a payment processing computer system 110 and a client computer system 120. The client system 120 may host a browser application 122 and may have access to the payment processing computer system 110 via a communications network 130. The communications network 130 may be a public network (e.g., the Internet, a wireless network, etc.) or a private network (e.g., a local area network (LAN), a wide area network (WAN), Intranet, etc.).

The client computer system 120 may utilize the browser application 122 to access payment processing services provided by the payment processing computer system 110. In one embodiment, the payment processing computer system 110 may host a system 112 that may be configured to confirm ownership of digital goods. As described above, a user may send a request to purchase a digital good (e.g., a song) from the client computer system 120. The request may be sent to a third party computer system 140 operated by a producer of digital goods and the requested song in particular and then forwarded to the payment processing computer system 110 together with the requested song. The payment processing computer system 110 may then authenticate the requesting user, if necessary, as being authorized to use a certain financial account and then engage the system to confirm ownership of digital goods 112 to complete a series of micro transactions with respect to the financial account.

As stated above, the series of micro transactions may be one or more small debits and credits to/from a financial account that are identifiable only to the holder of the financial account. The system to confirm ownership of digital goods 112 may then generate a code derived from information associated from the completed micro transactions and embed it into the song received from the third party computer system 140. The information derived from the completed micro transactions may include, but not limited to, the username associated with the financial account (e.g., where the user's financial account is associated with an online payment service), bank account type, bank account number, the amount involved in the micro transaction, the type and/or format of the requested digital good, the name of the requested song, etc.

In some embodiments, a copy of the requested digital good is provided to the payment processing computer system 110 from the third party computer system 140. The payment processing computer system 110 may then transmit to the third party computer system 140 the copy of the requested digital good modified to include the embedded code. The third party computer system 140 may then transmit the copy of the requested digital good modified to include the embedded code to the originator of the request to purchase the digital good. In some other embodiments, the payment processing computer system 110 may also be configured to serve as a producer of digital goods. A request from a user to purchase a song may then be received at the payment processing computer system 110. The payment processing computer system 110 may then transmit the copy of the requested song modified to include the embedded code directly to the computer system of the requesting user, e.g., to the client computer system 120. In yet another embodiment, a user may obtain a digital good from the third party computer system 140 and then send it to the payment processing computer system 110 for processing by the system 112 to confirm ownership of digital goods.

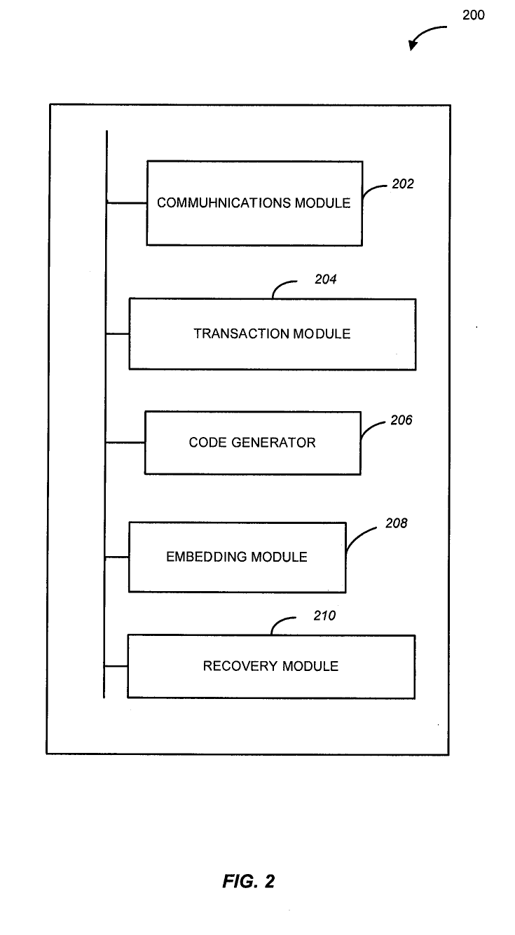

FIG. 2 is a block diagram of a system 200 to generate code suitable to confirm ownership of digital goods that, in some embodiments, corresponds to the system to confirm ownership of digital goods 112 of FIG. 1. As shown in FIG. 2, the system 200 includes a communications module 202, a transaction module 204, a code generator 206, and an embedding module 208. The communications module 202 may be configured to receive a request for a digital good from a client system (e.g., from the client system 120 of FIG. 1), as well as copies of digital goods and other information, such as information related to the requesting user's financial account. The transaction module 204 may be configured to complete one or more micro transactions with respect to a financial account being controlled by the requesting user. The code generator 206 may be configured to generate a code utilizing information derived from the completed one or more micro transactions. As mentioned above, the micro transactions may be one or more small debits and credits to/from a financial account that are identifiable only to the holder of the financial account. The information derived from the completed micro transactions may include, but not limited to, the username associated with the financial account (e.g., where the user's financial account is associated with an online payment service), bank account type, bank account number, the amount involved in the micro transaction, the type and/or format of the requested digital good, the name of the requested song, etc.

The embedding module 208 may be configured to embed the code generated utilizing information derived from the completed one or more micro transactions into a copy of the digital good. Thus generated code is suitable for confirming the user's ownership of the digital good. In one embodiment, the system 200 comprises an authentication module (not shown) that may be configured to obtain a user-supplied code associated with a request permit playback of a copy of a digital good on a client device (a DRM code embedded into the digital good), compare the user-supplied code to the code derived from the one or more micro transactions at the time when a request to purchase the digital good was made, and selectively permit playback of the copy of the digital good on the client device based on a result of the comparing.

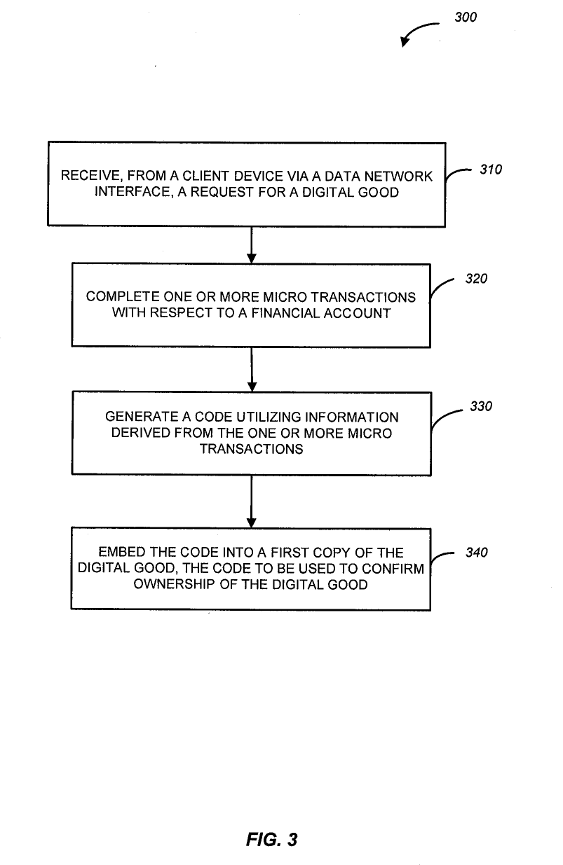

The system 200 may also include a recovery module 210, which may be configured to process a request from a user who wishes to reacquire a previously-purchased digital good. In one embodiment, the recovery module 210 may provide an instruction to the requestor to effectuate one or more micro transactions that match the one or more completed micro transactions that occurred when the user first purchased the digital good. If the recovery module 210 determines that the user was able to perform one or more micro transactions that match the one or more completed micro transactions that occurred when the user first purchased the digital good, the code generator 206 may be instructed to recreate the code utilizing information derived from the one or more micro transactions, and the embedding module 208 may be instructed to embed the recreated code into a copy of the digital good. As a result, the user may be provided with a copy of the previously-purchased digital good that contains the recreated code that can be used to confirm ownership of the digital good. An example method to generate a code that can be used to confirm ownership of digital goods can be described with reference to FIG. 3.

FIG. 3 is a flow chart of a method 300 to generate a code that can be used to confirm ownership of digital goods, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the payment processing computer system 110 of FIG. 1 and, specifically, at the system to generate code suitable to confirm ownership of digital goods shown in FIG. 2.

As shown in FIG. 3, the method 300 commences at operation 310, when the communications module 202 of FIG. 2 receives, from a client device via a data network interface, a request for a digital good. The transaction module 204, at operation 320, completes one or more micro transactions with respect to a financial account of the requesting user. Information identifying the user's financial account may be provided by the user together with the request to purchase a digital good. The identifying information may be, e.g., the account number, or the user's email address where the account is associated with an on-line payment service.

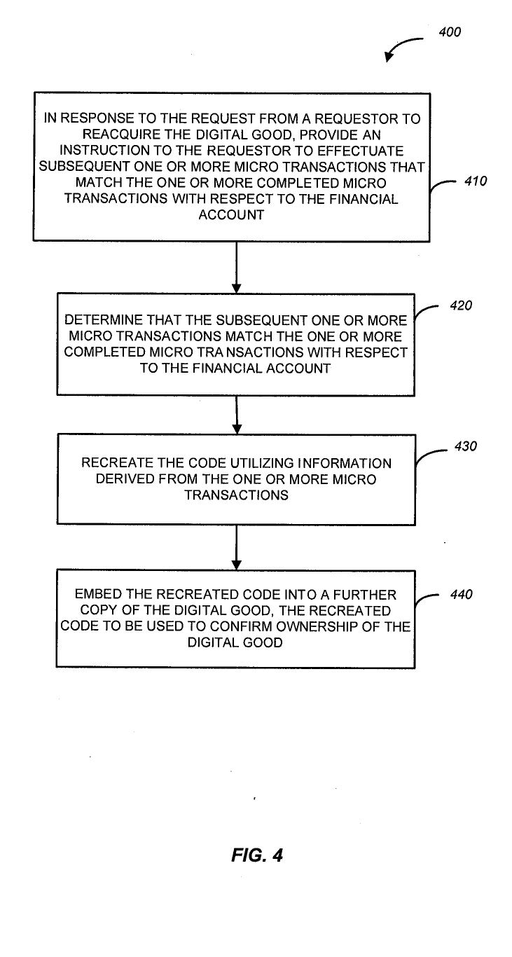

At operation 330, the code generator 306 generates a code utilizing information derived from the one or more micro transactions. As mentioned above, the micro transactions may be one or more small debits and credits to/from a financial account that are identifiable only to the holder of the financial account. The information derived from the completed micro transactions may include, but not limited to, the username associated with the financial account (e.g., where the user's financial account is associated with an online payment service), bank account type, bank account number, the amount involved in the micro transaction, the type and/or format of the requested digital good, the name of the requested song, etc. At operation 340, the embedding module 308 embeds the code generates, using information derived from the one or more micro transactions, into a copy of the digital good. The purchased digital good can be then transmitted directly to the user or to the computer system controlled by the producer of the digital good so that the producer of the digital good makes the copy of the digital good with embedded code available to the user (e.g., to the purchaser or to another user designated by the purchaser). An example method to recover a code that can be used to confirm ownership of digital goods can be described with reference to FIG. 4.

FIG. 4 is a flow chart of a method 400 to recover ownership of a digital good, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the payment processing computer system 110 of FIG. 1 and, specifically, at the system to generate code suitable to confirm ownership of digital goods shown in FIG. 2.

As shown in FIG. 4, the method 400 commences at operation 410, when the communications module 202 of FIG. 2 receives a request from a user indication that the user wishes to reacquire previously-purchased digital good, which causes the recovery module 210 to provide an instruction to the requestor to effectuate one or more micro transactions that match the one or more completed micro transactions that occurred when the user first purchased the digital good. At operation 420 the recovery module 210 determines whether the user was able to perform one or more micro transactions that match the one or more completed micro transactions that occurred when the user first purchased the digital good. At operation 430, the code generator 206 recreates the code utilizing information derived from the one or more micro transactions. The embedding module 208 embeds the recreated code into a new copy of the digital good at operation 440. As a result, the user may be provided with this new copy of the previously-purchased digital good that contains the recreated code and that can be used to confirm ownership of the digital good.

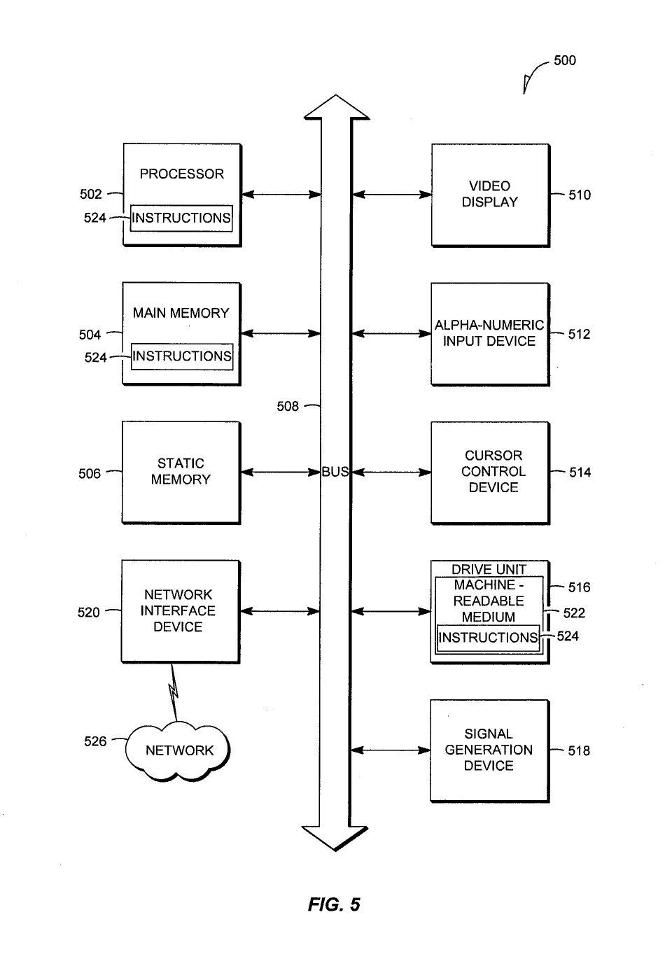

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, a method and system to confirm ownership of digital goods has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A computer-implemented system comprising:
receiving, from a client device via a data network interface, a request tier a digital good;
completing one or more micro transactions with respect to a financial account;
generating, using at least one processor, a code utilizing information derived from the one or more micro transactions;
embedding the code into a first copy of the digital good, the code to be used to confirm ownership of the digital good.

2. The method of claim 1, comprising transmitting the first copy of the digital good with the embedded code to a third party computer system.

3. The method of claim 1, comprising providing the first copy of the digital good with the embedded code to the client device.

4. The method of claim 3, comprising:
obtaining a user-supplied code;
comparing the user-supplied code to the code generated utilizing information derived from the one or more micro transactions; and
selectively permitting playback of the first copy of the digital good on the client device based on a result of the comparing.

5. The method of claim 1, wherein the receiving of the request for the digital good comprises receiving a request to purchase the digital good.

6. The method of claim 1, wherein the receiving of the request for the digital good comprises receiving a request to reacquire the digital good.

7. The method of claim 6, comprising:
in response to the request from a requestor to reacquire the digital good, providing an instruction to the requestor to effectuate subsequent one or more micro transactions that match the one or more completed micro transactions with respect to the financial account;
determining that the subsequent one or more micro transactions match the one or more completed micro transactions with respect to the financial account;
responsive to the determining, recreating the code utilizing information derived from one or more micro transactions; and
embedding the recreated code into a further copy of the digital good, the recreated code to be used to confirm ownership of the digital good.

8. The method of claim 1, wherein the one or more micro transactions comprise a deposit transaction.

9. The method of claim wherein the one or more micro transactions comprise a withdrawal transaction.

10. The method of claim 1, wherein the generating of the code utilizing information derived from the one or more micro transactions comprises utilizing one or more information items from a list consisting of a transaction amount, a user name associated with the financial account, a type of the financial account, and a type of the digital good.

11. A computer-implemented system comprising:
a communications module to receive, using at least one processor, from a client device via a data network interface, a request for a digital good;
a transaction module to complete, using the at least one processor, one or more micro transactions with respect to a financial account;
a code generator to generate, using the at least one processor, a code utilizing information derived from the one or more micro transactions;
embedding module to embed, using the at least one processor, the code into a first copy of the digital good, the code to be used to confirm ownership of the digital good.

12. The system of claim 11, wherein the communications module is to transmit the first copy of the digital good with the embedded code to a third party computer system.

13. The system of claim 11, wherein the communications module is to transmit the first copy of the digital good with the embedded code to the client device.

14. The system of claim 13, comprising an authentication module to, using the at least one processor:
obtain a user-supplied code;
compare the user-supplied code to die code generated utilizing information derived from the one or more micro transactions; and
selectively permit playback of the first copy of the digital good on the client device based on a result of the comparing.

15. The system of claim 11, wherein the request for the digital good is a request to purchase the digital good.

16. The system of claim 11, wherein the request for the digital good is a request to reacquire the digital good.

17. The system of claim 16, comprising a recovery module to, using the at least one processor:
in response to the request from a requestor to reacquire the digital good, provide an instruction to the requestor to effectuate subsequent one or more micro transactions that match the one or more completed micro transactions with respect to the financial account;
determine that the subsequent one or more micro transactions match the one or more completed micro transactions with respect to the financial account, wherein:
the code generator is to recreate the code utilizing information derived from the one or more micro transactions, and
the embedding module is to embed the recreated code into a further copy of the digital good, the recreated code to be used to confirm ownership of the digital good.

18. The system of claim 11, wherein the one or more micro transactions comprise one or more of a deposit transaction and a withdrawal transaction.

19. The system of claim 11, wherein the code generator is to utilize one or more information items from a list consisting of a transaction amount, a user name associated with the financial account, a type of the financial account, and a type of the digital good.

20. A machine-readable non-transitory, storage medium having instruction data to cause a machine to:
receive, from a client device via a data network interface, a request for a digital good;
complete one or more micro transactions with respect to a financial account;
generate a code utilizing information derived from the one or more micro transactions;
embed the code into a first copy of the digital good, the code to be used to confirm ownership of the digital good.
